(19) United States
(12) Patent Application Publication
(10) Pub. No.: US 2014/0110205 A1
(43) Pub. Date: Apr. 24, 2014

(54) NON-RAIL-BOUND VEHICLE

(71) Applicant: Andrej Dronnik, Berlin (DE)

(72) Inventor: Andrej Dronnik, Berlin (DE)

(73) Assignee: SIEMENS AKTIENGESELLSCHAFT, Muenchen (DE)

(21) Appl. No.: 14/122,898

(22) PCT Filed: May 23, 2012
(86) PCT No.: PCT/EP2012/059610

§ 371 Date: Nov. 27, 2013

(30) Foreign Application Priority Data
May 27, 2011 (DE) 10 2011 076 620.0

(51) Int. Cl. B60L 5/36

(52) U.S. Cl. CPC B60L 5/36
USPC 191/59.1

(57) ABSTRACT

A non-rail-bound vehicle, in particular a truck or bus, includes a current collector for feeding in electrical energy from a two-pole overhead line, the forward conductors and return conductors of which can each be contacted by a contact shoe of the current collector. The current collector has two support struts, which are rotatably articulated on the vehicle in such a way that they can pivot transversely to a longitudinal axis of the vehicle while guided in a common pivot plane. The support struts are connected in an articulated manner to a rocker carrying the contact shoes. In this way, the current collector can be safely connected to or disconnected from a contact wire during operation of the vehicle on multilane roadways having an electrified lane at least in sections, even at higher driving speeds, and can reliably maintain contact with the contact wire.

The invention relates to a non-rail-bound vehicle in accordance with the pre characterizing clause of claim 1.

There is adequate knowledge of how to equip rail-bound vehicles, such as for example electric locomotives, trains and streetcars, with current collectors for the supply of traction power which, for the purpose of feeding electrical energy into the vehicle, make a sliding contact with the contact wire of a conducting wire system. The track guidance from the rails enables a defined relative position to be maintained between the contact wire and the rail-bound vehicle, thus ensuring that in normal operation a reliable sliding contact can be maintained between the current collector and the contact wire. Much less widespread is the feeding in of external energy into electrically driven vehicles which are not rail-bound.

Thus, for example, a two-pole overhead conductor system for electrically driven vehicles in public local passenger transportation is known from printed patent specification DE 32 44 945 C1. Of the two overhead conductor wires, which run parallel to each other, one carries a voltage relative to ground, and the other serves as the neutral conductor. A trolleybus is equipped with a pair of trolley collectors to enable it to travel around within the overhead conductor system. In operation, the pair of trolley collectors adopts a raised position, in which their sliding bars lie correctly against the two overhead conductor wires. The trolley collectors are subject to the force from a raising spring, which provides the necessary contact pressure by the sliding bars on the overhead conductor wires. The trolley collectors are mounted on the roof of the trolleybus with articulation about an axis which runs horizontally and across the direction of travel, so that they can be lowered and then raised again. For the purpose of compensating for sideways deviations during travel relative to the course of the overhead conductor wires, the trolley collectors can also rotate about a vertical axis, so that they can maintain sliding contact with the overhead conductor wires. However, trolleybuses are vehicles which are restricted to a defined traffic lane, because sharp swerving maneuvers or overtaking maneuvers which require leaving the lane lead to a loss of contact between the trolley collectors and the overhead conductor wires.

Published patent application DE 102 56 705 A1 discloses a non-rail-bound vehicle, such as those used as trucks in open-cast mining for the transportation of ore, coal or spoil. For the purpose of supplying electricity for a motor in the vehicle, two pantographs are provided, which in operation are in contact with the contact wires of a two-pole overhead conductor via sliding bars. So that the vehicle is only ever steered in such a way that the sliding bars do not leave the contact wires, sensor bars which carry magnetic field sensors are arranged on the pantographs. These determine the magnetic field strength of the magnetic field generated by the current in the contact wire with such accuracy that the distance of the sensor from the contact wire can be determined on the basis of the measured field strength value. The information about the position of the sensor relative to the contact wire and thereby about the position of the pantograph and thereby of the entire vehicle relative to the contact wire can be communicated to the vehicle driver by means of a display unit so that he can perform appropriate steering movements immediately. It is also possible to supply the information from the sensors to a control unit for the automatic steering of the vehicle.

The trolley collectors known from trolleybuses suffer from the disadvantage that it is relatively difficult to hook the vehicles' trolley collectors onto and unhook them from the wires, and that when performing jerky steering actions it is possible for so-called collector derailing to occur, i.e. a loss of contact between the sliding bars and the overhead conductor wires. As a result, this system is unsuitable for roadways with an at least partially electrified traffic lane with non-electrified traffic lanes running in parallel therewith—for example, on multi-lane freeways. Finally, trolley collectors are also unreliable at relatively high speeds of 80 to 100 km/h, at which commercial vehicles may drive on freeways.

The solutions known from open-cast mining vehicles with one current collector each per contact wire also have the disadvantage that lateral movements of the vehicle in excess of 0.4 m may result in a loss of contact with the overhead line. In order to avoid such losses of contact, the current collector arrangement can also be designed so that it is wider than the vehicle, which is dangerous on public roads outside an open-cast mining area and is not permitted under road traffic regulations.

Hence, the object underlying the invention is to provide a generic vehicle on which the current collector can, even at higher travel speeds of 80 to 100 km/h, for example, be safely hooked onto and unhooked from the wires when operated on multi-lane routes with a traffic lane which is electrified, at least along sections, and can reliably maintain contact with the contact wire.

The object is achieved according to the invention by a non-rail-bound vehicle of the type referred to at the beginning with the features specified in the characterizing clause of claim 1. According to this, the current collector has two support struts which are articulated on the vehicle so that they can rotate and are restrained to pivot in a common plane of rotation across a longitudinal axis of the vehicle, where the support struts have an articulated joint to a rocker on which are mounted the sliding bars. By this means, a rigid design of framework is provided for the current collector which executes pivoting movements, in a pivoting plane which is across the direction of travel, to enable sideways steering movements of the vehicle to be compensated. The pivoting plane is essentially perpendicular to the longitudinal axis of the vehicle. By this means, the sliding bars of the current collector can maintain a reliable contact with the overhead conductor.

In an advantageous form of embodiment of the inventive vehicle, the support struts are coupled together by a linearly guided positioning bar, which can be moved across the longitudinal axis of the vehicle by means of a positioning drive. On the one hand, the positioning bar with its articulated joint to the support struts affords additional rigidity to the current collector frame. On the other hand it is possible to actively control the pivoting movement of the current collector by means of the positioning drive, for example an electric motor attached to the vehicle which engages with the positioning bar through a geared linkage. For this purpose, a sensor system can be arranged on the vehicle, for example a video camera with appropriate image analysis, which detects the position of the vehicle relative to the contact wires of the overhead conductor, and a regulation system which uses a planned/actual comparison to determine a control variable and actuates the positioning drive correspondingly.

In one preferred embodiment of the inventive vehicle, each support strut is constructed so that it can be extended or retracted telescopically by means of an actuator. Thus, the support struts can be in the form, for example, of positioning cylinders or other linear guides which enable the distance between the points of articulation of the support struts on the vehicle and on the rocker to be adjusted. This permits simple and secure hooking on or unhooking of the current collector when driving into or out of an electrified section. Over and above this, the loss in height of the rocker when the current collector pivots sideways can be compensated by extending the telescopic-type support struts. Finally, these support struts permit the height of the rocker to be adjusted for the relevant sag in the contact wires of the overhead conductor.

In an advantageous embodiment of the inventive vehicle the sliding bars have, on each of their side ends, downward sloping lead-in horns, and are joined together by an electrically insulating piece. The continuous sliding bar is highly rigid, with the sliding bar which contacts the forward conductor being electrically insulated from the sliding bar which contacts the return conductor. The downward sloping lead-in horns make it easier to reattach a current collector which has pivoted too far sideways relative to the contact wire.

In an advantageous embodiment of the inventive vehicle, the rocker has two parts which are electrically insulated from one another, on each of which the sliding bars have a sprung arrangement. The rocker is also split into two parts which are electrically insulated from each other, and these are associated with the sliding bars concerned. The rocker permits a rotational movement, together with the sliding bars, about a horizontal axis of rotation which runs across the direction of travel. By this means, obstacles on the contact wires can be accommodated by a movement of the rocker, in order to avoid more serious damage to the sliding bars.

In another advantageous form of embodiment of the inventive vehicle, each support strut has springing to accommodate longitudinal compression movements and/or for the purpose of setting a constant contact pressure between the sliding bars and the forward or return conductor, as applicable. The springing could be in the form, for example, of air springs arranged between the articulation point on the vehicle and the positioning cylinder. Longitudinal compression movements can be damped by the air springing, but it also permits the extension and retraction of the support struts to be adjusted so that the sliding bars always apply an approximately constant force on the contact wires as they move along the overhead conductor. All in all, for inventive vehicles the springing improves the quality of the movement along the two-pole overhead conductor.

In another preferred embodiment of the inventive vehicle, each support strut is joined to the vehicle by an electrically insulating support. These insulating supports ensure that the inventive current collector is securely affixed to the vehicle and prevent any flow of current to the vehicle through these fixing points. The traction current is fed into the rocker through flexible conducting pieces, from each of which it is fed, through two conductor rails which have an articulated joint, into the pivoting joint on the vehicle and from there via flexible current conductors into the vehicle's traction system.

In another preferred embodiment of the inventive vehicle, the current collector is arranged behind a driver's cab on the vehicle, looking in the direction of travel. The essentially vertical arrangement of the support struts means that the current collector can be arranged so it occupies little space, between the driver's cab and the load body of the vehicle, with the plane in which the current collector pivots also being arranged between these parts of the vehicle. No installation space is required above the driver's cab or the body. The current collector can be joined directly to the chassis of the vehicle. The weight of the current collector is well distributed across the height of the vehicle, so that the effect of the current collector on the handling of the vehicle can be kept small.

Further advantages and characteristics of the inventive vehicle emerge from the following description of an exemplary embodiment, which will be explained in more detail by reference to the drawings, which show schematically

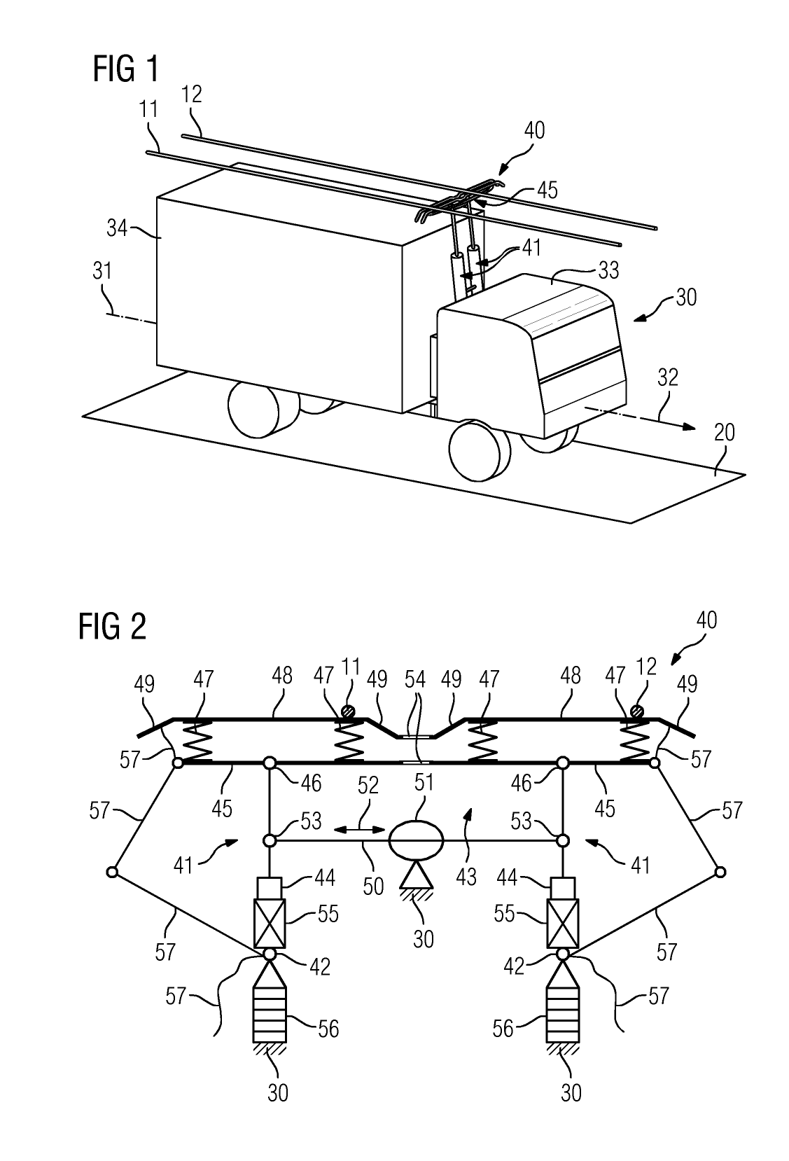

FIG. 1 a perspective view of an inventive vehicle in, and

FIG. 2 the current collector of the inventive vehicle looking in the direction of the vehicle's longitudinal axis.

As shown in FIG. 1, a two-pole overhead conductor with a forward conductor 11 and, running parallel to it, a return conductor 12, is provided for the electrification of a traffic lane 20. The forward and return conductors, 11 and 12 respectively, of the overhead conductor are also referred to below as the individual contact wire or together as the contact wires. They are arranged roughly centrally above the traffic lane 20 by means of infrastructure facilities which are not shown, such as masts, brackets, steady arms, load-bearing cables, hangers and the like.

The traffic lane 20 can be, for example, the right hand traffic lane of a multi-lane freeway. By this means it is possible to feed electrical energy into vehicles 30 with a current collector 40, in order to provide traction energy for an electric or hybrid drive in the vehicle 30, or in order to tap off to the overhead conductor braking energy from the vehicle 30.

Looking in the direction of travel 32 of the vehicle 30, the current collector 40 is arranged on a longitudinal axis 31 of the vehicle behind a driver's cab 33, and in front of a load body 34. The current collector 40 has two support struts 41 arranged essentially vertically, the lower ends of these being articulated onto the vehicle 30 and a rocker 45 being mounted on their upper ends. The support struts 41 lie in a pivoting plane 43 (cf. the drawing plane for FIG. 2), which is located essentially perpendicularly to the longitudinal axis 31 of the vehicle and between the driver's cab 33 and the load body 34. Accordingly the rocker 45 can perform pivoting movements from side to side in this pivoting plane 43, that is essentially horizontally and across the direction of travel 32, in order to keep the sliding bars 48 (cf. FIG. 2) which are arranged on the rocker 45 in sliding contact with the contact wires 11 and 12, as applicable. In FIG. 1, for example, looking in the direction of travel 32 the vehicle 30 has gone to the left hand edge of the traffic lane 20, which the current collector 40 compensates for by a pivoting movement towards the right when looking in the direction of travel 32.

As shown in FIG. 2, the current collector 40 incorporates two parallel-oriented support struts 41, each of which is articulated to the vehicle 30 by a pivoting joint 42 so that it can rotate. The pivoting joints 42 permit a rotational movement of the support struts 41 in a common pivoting plane 43, which in FIG. 2 is represented by the plane of the drawing; the axes of rotation of the pivoting joints 42 thus extend parallel to the longitudinal axis 31 of the vehicle. The support struts 41 have positioning cylinders 44 to extend and retract them in a telescopic manner. Mounted on the support struts 41 and arranged with a horizontal orientation across the direction of travel 32 is a rocker 45, joined by rotary joints 46 to the upper ends of the piston rods of the positioning cylinders 44. The rocker 45 incorporates two sliding bar holders which are arranged one behind the other in the direction of travel 32 and are mounted on springs 47, attached to each of which are two sliding bars 48, one beside the other, and arranged at the ends of which on each side are downward sloping lead-in horns 49 (cf. FIG. 1). Each pair of sliding bars 48, arranged one behind the other, slides along one of the contact wires, 11 or 12 as applicable. The rocker 45 can rotate about a rocker axis which is oriented horizontally and across the direction of travel 32, to enable it to accommodate the tilting of a sliding bar 48 when it runs into an obstacle on the contact wire 11 or 12, as applicable.

The two support struts 41 are joined by a horizontal positioning bar 50 which is guided linearly within the pivoting plane 43. The positioning bar 50 can be moved, at an angle to the longitudinal axis 31 of the vehicle, by means of a positioning drive 51, which is constructed as a linear drive with a geared linkage, and is affixed to the vehicle 30. This positioning movement 52 is transmitted to the support struts 41 via couplings 53. The setpoint variable for the positioning movement 52 is issued by a regulation system, not shown. The regulation system has a sensor system for determining the position of the vehicle 30 relative to the overhead conductor's contact wires, 11 and 12 respectively, for example a video camera with image analysis. This determines how far the rocker 45 must be pivoted to one side in order that the sliding bars 48 slide within their working range along the contact wires 11 and 12, as applicable. Control interventions of this type may be necessary if the vehicle needs to perform swerving or overtaking maneuvers.

They can also be necessary if the contact wires, 11 and 12 respectively, do not run centrally above the traffic lane 20, as is the case for example along curves in the lane.

Because the rocker 45, and with it the sliding bars 48, sink slightly when there is a sideways positioning movement 52, the positioning cylinders 44 can be extended in order to compensate for this loss of height. Extension or retraction, as appropriate, of the positioning cylinders 44 is also of advantage in order to be able to slide along the contact wires, 11 and 12 respectively, with a constant pressure where they sag between the masts. Finally, the extension and retraction of the positioning cylinders 44 is used respectively for hooking onto or unhooking from the wires when the vehicle 30 drives into or leaves the electrified traffic lane 20—such as at access points and exits or crossroads on freeways, and during overtaking maneuvers or when making an emergency stop on the roadside shoulder. For the purpose of compensating for longitudinal compression, each support strut 41 has springing 55 which can, for example, be in the form of air springs. Apart from the damping which this effects, it can also be used to raise and lower the support struts 41. Here, in order to effect small springing movements and larger raising and lowering movements of the support struts 41, and hence of the sliding bars 48, a geared linkage is provided. The springing facilities 55 are constructed in such a way that the sliding bars 48 always press against the contact wires, 11 and 12 respectively, with a constant force.

For the purpose of electrical isolation of the vehicle 30 from the current collector 40, each of the support struts 41 is joined to the vehicle 30 via an electrically insulating post 56. The rocker 45 together with the holders for the sliding bars 48 are electrically isolated from each other by insulating pieces 54, but mechanically they are joined to each other. The insulating pieces 54 can, for example, be in the form of chains, so that the contact wires, 11 and 12 respectively, cannot slip down in the middle between the sliding bars 48.

The traction current is tapped off from the forward conductor 11 by the pair of sliding bars 48 lying one behind the other, shown on the left in FIG. 2, and is fed onward to the rocker 45 via a flexible current conductor 57. Between the rocker 45 and the pivoting joint 42 on the vehicle side, the current conductor 57 continues as two linear conductor rails which have an articulated joint. From the pivoting joint 42, a flexible current conductor 57 feeds the traction current to the traction system of the vehicle 30. From this, the return current is fed back to the return conductor 12 via current conductors 57 of the same construction. The conductor rails, with their articulated joints to each other, ensure that the positioning cylinders 44 can be safely retracted and extended without damage to the current conductors 57. Finally, each support strut 41 is joined to the vehicle 30 through an electrically insulating post 56, so that the traction current can be fed along a defined conducting path.

All in all, the support frame for the rocker 45 formed by the support struts 41 and positioning bars 50 guarantees adequate rigidity in all directions. The current collector 40 occupies no installation space above the driver's cab 33, so that the latter can be hinged aside with no difficulty. The load body 34 can also be taken off with no conflict with the current collector 40. The weight of the current collector 40 is well distributed across its height, so that the current collector 40 does not affect the handling of the truck 30. The width of the current collector 40 can be kept less than the width of the vehicle 30, and the permissible overall height of the vehicle 30 is likewise not exceeded. The current collector 40 can be reliably hooked onto and unhooked from the overhead conductor, and can maintain reliable contact with the contact wires 11 and 12 respectively when the vehicle 30 moves sideways relative to the overhead conductor by up to 0.4 m. The U-shaped rocker 45 with sliding bars 48 can also slide along the overhead conductor safely at speeds of 80 to 100 km/h.

1-8. (canceled)

9. A non-rail-bound vehicle, comprising:
a current collector configured to feed in electrical energy from a two-pole overhead conductor having forward and return conductors;
said current collector having a rocker;
said current collector having sliding bars each mounted on said rocker and configured to contact a respective one the forward and return conductors; and
said current collector having two support struts each with an articulated connection to said rocker, said support struts being rotatably articulated on the vehicle for pivoting and being guided to pivot in a common pivot plane transverse to a longitudinal axis of the vehicle.

10. The non-rail-bound vehicle according to claim 9, which further comprises a linearly guided positioning bar coupling said support struts together, and a positioning drive configured to move said positioning bar transverse to said longitudinal axis of the vehicle.

11. The non-rail-bound vehicle according to claim 9, which further comprises positioning cylinders each configured to telescopically extend or retract a respective one of said support struts as appropriate.

12. The non-rail-bound vehicle according to claim 9, which further comprises an electrically insulating piece interconnecting said sliding bars, said sliding bars each having a lateral end and a respective downward sloping lead-in horn on said lateral end.

13. The non-rail-bound vehicle according to claim 9, wherein said rocker has two parts being electrically insulated from each other, and said sliding bars are each disposed on a respective one of said parts with spring mountings.

14. The non-rail-bound vehicle according to claim 9, wherein each of said support struts has a respective spring element configured to at least one of accommodate longitudinal compression movements or set a constant contact pressure by each of said sliding bars on a respective one of the forward and return conductors.

15. The non-rail-bound vehicle according to claim 9, which further comprises electrically insulating posts each connecting a respective one of said support struts to the vehicle.

16. The non-rail-bound vehicle according to claim 9, wherein said current collector is disposed behind a driver's cab of the vehicle in direction of travel of the vehicle.

17. The non-rail-bound vehicle according to claim 9, wherein the non-rail-bound vehicle is a truck or bus.
